(19) United States
(12) Patent Application Publication
(10) Pub. No.: US 2007/0056524 A1
(43) Pub. Date: Mar. 15, 2007

(54) Apparatus and methods for containing and transporting animals

(76) Inventor: Rosanne Barca, Cranford, NJ (US)

Correspondence Address: LAW OFFICES OF RITA C. CHIPPERSON, 89 HEADQUARTERS PLAZA NORTH, 14TH FLOOR, SUITE 1472, MORRISTOWN, NJ, 07960, US

(21) Appl. No.: 11/495,994

(22) Filed: Jul. 27, 2006

Related U.S. Application Data
(60) Provisional application No. 60/703,399, filed on Jul. 28, 2005.

(51) Int. Cl. A01K 1/03

(52) U.S. Cl. 119/496

(57) ABSTRACT

Disclosed are apparatus and methods for containing and transporting animals in public places or during travel. In one aspect of the present invention, the animal is contained and/or transported via a wheeled apparatus having foot-actuated locking wheels. Also disclosed is a plurality of handles to aid an operator with lifting or securing the apparatus either alone or with the help of others. Such handles may be locking or freely moveable. In another aspect, access to the door is bifurcated to allow access to and for the animal while containing the animal within the apparatus. A plurality of attachment mechanisms for accessories such as feeding and watering accessories, padding and bedding accessories, and restraint accessories are also disclosed. Partitions for subdividing the space within the apparatus are also provided. Furthermore, a triangular eyelet is provided for improved directional control. Shock absorbers are also provided to increase ride comfort.

### CROSS-REFERENCE TO RELATED APPLICATIONS

This application claims the benefit of the U.S. provisional patent application entitled “Pet Carrier in Motion”, having Ser. No. 60/703,399, filed Jul. 28, 2005, which is incorporated by reference in its entirety as if fully set forth herein.

### BACKGROUND OF THE INVENTION

Embodiments of the present invention generally relate to apparatus and methods for containing and transporting animals. More specifically, the present invention relates to apparatus and methods for effortlessly containing and transporting an animal in public places or during travel via a car, airplane, train, or the like.

Systems are known in the art for transporting a pet. Many such systems have been created in the form of a housing containing a hollow body. In its most simplistic form, such systems include a hollow housing in which one side of the housing provides closeable access to the interior of the housing. In one such system, the housing is comprised of three walls, a floor, and a ceiling fabricated from a rigid material such as plastic. A fourth wall, in the form of a grill, is movably attached to the housing such that the pet may be placed within the house. The grill-like nature of the fourth wall along with the vents in the remaining three walls allows the housing to be properly ventilated for the pet. Additionally, some such systems include locking mechanisms for the grill to ensure that the pet is retained within the housing.

Similar systems additionally include a handle, stop, and wheels for use during transportation of a pet. One such system includes two wheels located on the rear of the carrier and a handle and stop located on the front of the carrier. The stop is located such that the carrier will not roll when the stop rests upon the ground. However, upon lifting the handle such that the stop is no longer in contact with the ground, the rear wheels of the carrier engage the ground and the carrier may be rolled via the rear wheels. Some such systems additionally include adjustable or collapsible handles, as well as separable top and bottom sections to simplify cleaning and storage. Yet another similar system has four wheels that include hand-operated locking mechanisms that secure the carrier in a stationary position.

In another similar system, an animal carrier is disclosed having a rigid bottom attached to plastic mesh walls. The two side walls are curved in an inverted U-shape such that they form the ceiling of the carrier. One of the remaining walls is removably attached to the carrier with a zipper to allow the pet to be placed within the carrier. The carrier further includes a support structure in the center of the ceiling that includes a handle and two coupling rings. A user may carry the carrier via the handle or attach a strap to the two coupling rings. Other features such as a tray and absorbent pad on the floor of the carrier for hygiene or pockets may also be included.

In yet another similar system, a carrier is comprised of a rectangular, collapsible wire cage. In its collapsed state, the carrier may be inserted into a fabric bag. The cage is inserted into the bag by unzipping a front panel of the bag along three sides. The bag additionally includes straps on the two panels adjacent to the front panel to facilitate carrying of the collapsed cage. The floor of the bag is attached to a board to enhance the structural integrity of the bag. Four wheels and an additional strap are attached to the front panel to provide an alternative method for transporting the collapsed carrier. A pocket for storage is also included in the rear panel of the bag. Similar carriers with varying shapes but identical features have also been disclosed.

### BRIEF SUMMARY OF THE INVENTION

Briefly stated, in one aspect of the present invention, an animal containment and transportation apparatus is provided. This apparatus includes a housing, at least one access device coupled to the housing for placing at least one animal in the housing, and at least one wheel mechanism coupled to at least one downwardly facing side of the housing to facilitate movement of the housing, wherein the at least one access device is partitioned to allow a user of the apparatus to open a portion of the access device while a remainder of the access device remains in a closed position.

In another aspect of the present invention, an animal containment and transportation apparatus is provided. This apparatus includes a housing, at least one access device coupled to the housing for placing at least one animal in the housing, and at least two wheel mechanisms coupled to at least one downwardly facing side of the housing to facilitate movement of the housing, wherein at least one of a first of the at least two wheel mechanisms is located toward a rear end of the housing and at least one of a second of the at least two wheel mechanisms is located toward a front end of the housing, and wherein the at least one of a first of the at least two wheel mechanisms are fixed and the at least one of a second of the at least two wheel mechanisms swivel.

In another aspect of the present invention, an animal containment and transportation apparatus is provided. This apparatus includes a housing, at least one access device coupled to the housing for placing at least one animal in the housing, and at least one wheel mechanism coupled to at least one downwardly facing side of the housing to facilitate movement of the housing, the at least one wheel mechanism equipped with at least one foot-actuated locking mechanism.

In yet another aspect of the present invention, an animal containment and transportation apparatus is provided. This apparatus includes a housing, at least one access device coupled to the housing for placing at least one animal in the housing, and at least one wheel mechanism coupled to at least one downwardly facing side of the housing to facilitate movement of the housing, the at least one wheel mechanism equipped with at least one shock absorption mechanism.

In yet another aspect of the present invention, an animal containment and transportation apparatus is provided. This apparatus includes a housing, at least one access device coupled to the housing for placing at least one animal in the housing, at least one wheel mechanism coupled to at least one downwardly facing side of the housing to facilitate movement of the housing, and at least one primary handle to facilitate the movement of the housing, the at least one primary handle having an adjustable length.

In another aspect of the present invention, an animal containment and transportation apparatus is provided. This apparatus includes a housing, at least one access device coupled to the housing for placing at least one animal in the housing, at least one wheel mechanism coupled to at least one downwardly facing side of the housing to facilitate movement of the housing, and at least one primary handle to facilitate movement of the housing, wherein at least one primary handle folds to a folded position atop the housing, and wherein the at least one primary handle does not protrude beyond a rearwardly facing surface of the housing when the at least one primary handle is in the folded position.

In still another embodiment of the present invention, an animal containment and transportation apparatus is provided. This apparatus includes a housing, at least one access device coupled to the housing for placing at least one animal in the housing, at least one wheel mechanism coupled to at least one downwardly facing side of the housing to facilitate movement of the housing, and at least one secondary handle, wherein the at least one secondary handle folds to a folded position below at least one surface of the housing, and wherein the at least one secondary handle does not protrude beyond the at least one surface of the housing when the at least one secondary handle is in the folded position.

In yet another embodiment of the present invention, an animal containment and transportation apparatus is provided. This apparatus includes a housing, at least one access device coupled to the housing for placing at least one animal in the housing, at least one wheel mechanism coupled to at least one downwardly facing side of the housing to facilitate movement of the housing, and at least one eyelet coupled to the housing.

In another embodiment of the present invention, an animal containment and transportation apparatus is provided. This apparatus includes a housing having at least one storage compartment located in a location selected from the group consisting of in at least one upwardly facing surface of the housing, atop at least one upwardly facing surface of the housing, and combinations thereof, at least one access device coupled to the housing for placing at least one animal in the housing, and at least one wheel mechanism coupled to at least one downwardly facing side of the housing to facilitate movement of the housing.

In still another embodiment of the present invention, an animal containment and transportation apparatus is provided. This apparatus includes a housing, at least one access device coupled to the housing for placing at least one animal in the housing, at least one wheel mechanism coupled to at least one downwardly facing side of the housing to facilitate movement of the housing, and at least one container removably attached to the housing.

In another embodiment of the present invention, an animal containment and transportation apparatus is provided. This apparatus includes a housing, at least one access device coupled to the housing for placing at least one animal in the housing, at least one wheel mechanism coupled to at least one downwardly facing side of the housing to facilitate movement of the housing, and at least one attachment mechanism for attaching at least one of the group consisting of an accessory, a restraint, and combinations thereof to the housing.

In yet another embodiment of the present invention, an animal containment and transportation apparatus is provided. This apparatus includes a housing, at least one access device coupled to the housing for placing at least one animal in the housing, at least one wheel mechanism coupled to at least one downwardly facing side of the housing to facilitate movement of the housing, and at least one partition for partitioning a space internal to the housing.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1 is a perspective view of an apparatus for containing and transporting an animal in accordance with one exemplary embodiment of the present invention;

FIG. 2 is an enlarged view of a wheel mechanism in accordance with the exemplary embodiment of the present invention depicted in FIG. 1;

FIG. 3 is a rear view of the exemplary embodiment of the present invention depicted in FIG. 1;

FIG. 4 is a perspective view of a container accessory in accordance with one embodiment of the present invention;

FIG. 5 is a cross-sectional view of the exemplary embodiment of the present invention depicted in FIG. 1 taken along lines 5-5 of FIG. 1;

FIG. 6 is a cross-sectional view of the exemplary embodiment of the present invention depicted in FIG. 1 taken along lines 6-6 of FIG. 1;

FIG. 7 is an exploded view of an access device pad in accordance with one embodiment of the present invention; and

FIG. 8 is an assembled view of the access device pad depicted in FIG. 7.

### DETAILED DESCRIPTION OF THE INVENTION

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a handle” includes a plurality of handles. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

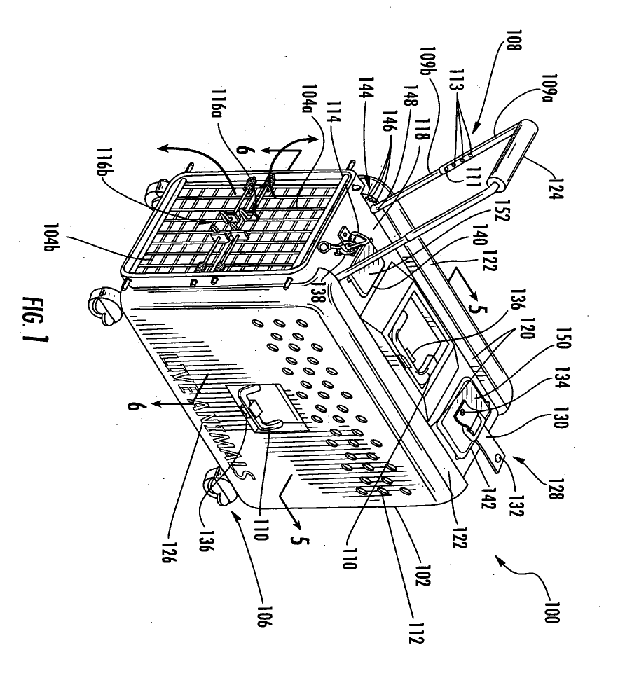

Referring first to FIG. 1, depicted is animal carrier 100 in accordance with one embodiment of the present invention. Animal carrier 100 includes, inter alia, housing 102, access device 104, wheel mechanisms 106, primary handle 108, secondary handles 110, vents 112, eyelet 114, and indicia 126. Animal carrier 100 facilitates traveling with an animal, such as an animal, as it allows the owner to pull animal carrier 100, thereby activating its wheels, rather than carrying it. This is particularly important for those with limited physical strength such as children and elderly individuals, however, animal carrier 100 facilitates animal containment and transportation for all individuals regardless of age. Animal carrier further facilitates containment and transportation of an animal in public places or areas including, but not limited to, dog shows, parks, etc.

In some aspects of the present invention, housing 102 is formed of a reinforced, heavy-duty plastic or the like. However, any material capable of restraining an animal may be substituted without departing from the scope of the present invention. Housing 102 may also be manufactured in a variety of shapes and sizes to accommodate varying sized animals. Housing 102 preferably includes vents such as vents 112 to ensure adequate air supply to an animal contained in animal carrier 100. Although vents 112 are circular and are located throughout the upper half of both sides of housing 102, varying styles and locations for such vents may be substituted without departing from the scope hereof.

Access device 104 is moveably attached to an aperture within housing 102 sized to allow an animal to pass therethrough. In some aspects of the present invention, access device 104 is a door formed of a metal mesh grill attached to housing 102 via hinges. In some embodiments, the metal mesh grill is a high gauge metal that prevents the animal contained within animal carrier 100 from bending or otherwise distressing access device 104. Access device 104 may include one or more locking mechanisms such as a double sprung latches (e.g., latches 116a and 116b) capable of retaining access device in a closed position such that an animal contained within animal carrier 102 cannot escape. However, other forms of access devices and access device locking mechanisms may be substituted without departing from the scope hereof.

In some embodiments of the present invention such as that depicted in FIG. 1, access device 104 is bifurcated in a manner that allows the top or bottom half of access device 104 to be opened independent of the bottom or top half of access device 104, respectively. This ability provides a variety of benefits. For example, the top half of access device 104 may be opened to allow the user to attach a leash, collar, or the like to the animal prior to fully opening access device 104. In such scenarios, allowing the lower half of access device 104 to remain in a closed position retains the animal within animal carrier 100 until the leash, collar, or the like is securely attached to the animal. This minimizes the potential for the animal to escape the owner's control, particularly in a public facility, due to elimination of the owner's need to fully open access device 104 before affixing the leash, collar, or the like to the animal. In addition, the ability to open one half of access device 104 allows a user to access the inside of animal carrier 100 while retaining the animal therein. This may be useful for tasks including, but not limited to, feeding and watering the animal, giving a treat to the animal, arranging the animal's bedding, etc. Furthermore, opening of the top half of access device 104 allows the animal to stick its head through the opening to view the area surrounding animal carrier 100 without having the ability to leave same. This may provide comfort to the animal since it allows the animal to become more comfortable with its surroundings and feel less confined. Although FIG. 1 depicts an access device partitioned in halves, other configurations (e.g., thirds, quarters, etc.) may be substituted without departing from the scope of the present invention. In addition, although FIG. 1 depicts a bifurcated access device 104 in which the top half of access device 104 opens upward and the bottom half of access device 104 opens downward, alternate methods of opening access device 104, and the sections thereof, may be substituted. For example, access device 104 and each of the sections thereof may open leftward, rightward, upward, or downward without departing from the scope of the present invention. Similarly, access device 104, and the sections thereof, may be hinged to housing 102 vertically or horizontally in any manner without departing from the scope of the present invention.

In other aspects of the present invention, the downwardly facing surface of housing 102 includes a plurality of wheel mechanisms 106. Such wheels may be fixed, may swivel, or may include a combination of fixed and swivel wheels to aid an operator with control and movement of animal carrier 100. For example, in one embodiment of the present invention, the rear wheels are fixed and the front wheels swivel. However, other combinations of fixed and swivel wheels may be substituted.

In some embodiments of the present invention, wheel mechanisms 106 are lockable. The locking capability allows animal carrier 100 to be fixed in a stationary position when it is not in motion. Such a position prevents accidental or unintended movement of animal carrier 100, which may cause injury or discomfort to the animal contained within animal carrier 100. However, non-locking wheels may be used without departing from the scope of the present invention.

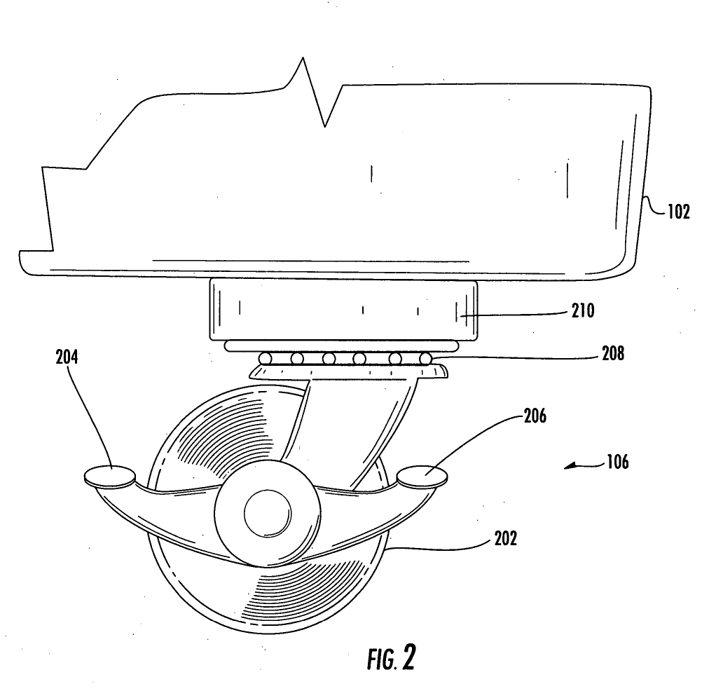

Referring now to FIG. 2, depicted is a magnified view of wheel mechanism 106 of FIG. 1. As depicted, wheel mechanism 106 is foot actuated. Such actuation facilitates locking of wheel mechanisms 106 as the user is not required to free his or her hands prior to such locking. This feature may be particularly important when traveling through an airport, bus station, or the like as a person will typically be transporting luggage or other items (e.g., purse, travel bag, travel tickets, reading materials, etc.) than the animal contained in animal carrier 100.

As depicted, wheel mechanism 106, which is attached to a downwardly facing surface of housing 102, includes, inter alia, wheel 202, unlocking foot pedal 204, locking foot pedal 206, and swivel mechanism 208. Wheels 202 may be virtually any type of wheel as known in the art capable of supporting the weight of animal carrier 100 and the animal contained therein. Wheels equipped with unlocking foot pedal 204 and locking foot pedal 206 are commercially available in a variety of embodiments such as fixed, swivel, etc. During use of animal carrier 100, an operator depresses unlocking foot pedal 204 with a foot, cane, or the like to index wheel mechanism 106 to a moveable position (i.e., the wheels are unlocked and are capable of rolling). Similarly, an operator depresses locking foot pedal 206 with a foot, cane, or the like to index wheel mechanism 106 to an immoveable position (i.e., the wheels are locked and are incapable of rolling). Furthermore, if wheel mechanism 106 is a swiveling mechanism, it may include swivel devices 208 such as a plurality of metal balls or the like. Although FIG. 2 depicts a pedal-actuated locking wheel mechanism 106, other foot-actuated and non-foot-actuated embodiments of wheel mechanism 106 may be substituted without departing from the scope of the present invention.

Some aspects of the present invention may further include shock absorbers such as shock absorber 210. In its simplest form, shock absorber 210 is a simplistic pad formed of virtually any type of shock absorbent material including, but not limited to, rubber, elastomer, and the like. In its more complex forms, shock absorbers more complex devices, as are commercially available, including but not limited to those having adjustable settings (e.g., hard, medium, soft, etc.) to accommodate traversing a variety of terrains. The incorporation of shock absorption in the systems of the present invention maximizes the comfort of the animal contained within the animal carrier, thereby potentially minimizing the anxiety created by containment or transport via animal carrier 100.

Referring back to FIG. 1, some aspects of the present invention also include primary handle 108. In the depicted embodiment, primary handle 108 is a telescoping handle that may be lengthened or shortened as required by a user. In some embodiments of the present invention, primary handle 108 may be locked in a variety of lengths to accommodate comfortable use of animal carrier 100 by a variety of people having different heights, sizes, and/or handle preferences. For example, as depicted in FIG. 1, primary handle 108 may include first primary handle section 109a and second primary handle section 109b, wherein second primary handle section 109b slides within first primary handle section 109a. Primary handle 108 may be locked at a particular length by allowing at least one spring-loaded button 111 located on an inwardly facing surface of second primary handle section 109b to pass through at least one of a plurality of first primary handle section apertures 113. In the depicted embodiment, spring-loaded buttons 111 and first primary handle section apertures 113 are located on both inwardly facing surfaces of second and first primary handle sections 109b and 109a, respectively, however, only one inwardly facing surface is depicted in FIG. 1 (i.e., the other inwardly facing surface is hidden due to the angle of the perspective view). Although the method of locking the length of primary handle 108 described herein includes spring-loaded buttons and corresponding apertures, alternate mechanisms for locking the length of primary handle 108 may be substituted without departing from the scope of the present invention.

Furthermore, when the telescoping handle is positioned in a completely retracted state, it is of a sufficiently short length that it may be folded atop housing 102 without protruding beyond the rearwardly facing surface thereof. In some embodiments of the present invention such as that depicted in FIG. 1, primary handle 108 is folded atop housing 102 such that it surrounds the perimeter of the secondary handle 110 located atop recessed upwardly facing surface 118 of housing 102 while also fitting within inwardly facing surfaces 120 of sides 122 of housing 102. Such a configuration allows primary handle 108 to be folded in a manner that does not interfere with lifting, carrying, or otherwise transporting animal carrier 100 via secondary handles 110 or otherwise. For example, animal carrier 100 may be secured in a vehicle or other location via seatbelts, bungee cables, or other retaining mechanisms, as discussed in greater detail below, without the interference of a protruding primary handle 108. Additionally, primary handles 108 may include handle covers 124, which may be padded or otherwise configured to increase an operator's comfort during use, particularly prolonged use, of animal carrier 100.

In another aspect of the present invention, primary handle 108 also includes angular locking mechanism 144, which includes a plurality of spring-loaded buttons 146 and second primary handle section apertures 148. Angular locking mechanism 144 may be locked at a variety of angles to accommodate comfortable use of animal carrier 100 by a variety of people having different heights, sizes, and/or handle preferences. Primary handle 108 may be locked at a particular angle by allowing at least one spring-loaded button 146 located on inwardly facing surfaces 120 of sides 122 of housing 102 to pass through at least one of a plurality of second primary handle section apertures 148. In the depicted embodiment, spring-loaded buttons 146 and second primary handle section apertures 148 are located on both inwardly facing surfaces 120 of sides 122 of housing 102, however, only one inwardly facing surface is depicted in FIG. 1 (i.e., the other inwardly facing surface is hidden due to the angle of the perspective view). Although angular locking mechanism 144 includes spring-loaded buttons and corresponding apertures, alternate mechanisms for locking the angle of primary handle 108 may be substituted without departing from the scope of the present invention.

In some embodiments of the present invention, primary handle locking mechanism 128 is provided. Such mechanism retains primary handle 108 in place such that it does not disengage from upwardly facing surface 118 of housing 102. In the embodiment of the present invention depicted in FIG. 1, such mechanism includes strap 130 that wraps around primary handle 108. A first end of strap 130 includes snap 134, which, in one embodiment of the present invention, snaps atop a snap receiving base located on an upwardly facing surface of cover 150. However, the snap receiving base for snap 134 may also be located elsewhere (e.g., atop upwardly facing surface 118 of housing 102, upon rearwardly facing surface 302 of housing 102, etc.) without departing from the scope of the present invention.

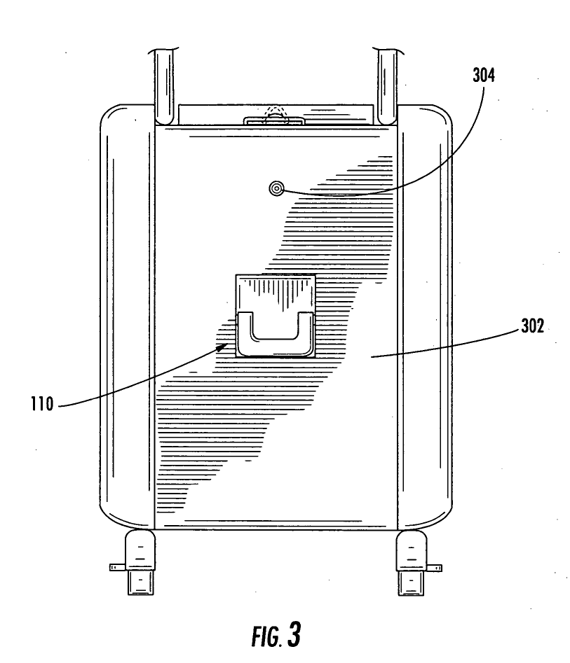

A second end of strap 130 includes snap 132, which snaps onto snap receiving base 304 (FIG. 3), which, in one embodiment of the present invention, is mounted atop recessed rearwardly facing surface 302. However, snap receiving base 304 may also be located elsewhere (e.g., atop upwardly facing surface 118 of housing 102, etc.) without departing from the scope of the present invention. In some aspects of the present invention, strap 130 may be adjustable to allow an operator to tighten primary handle 108 to upwardly facing surface 118. However, alternate primary handle locking mechanisms including, but not limited to, clips, Velcro®, and the like may be substituted without departing from the scope of the present invention.

One or more secondary handles 110 may also be included in embodiments of the present invention for a variety of purposes. In some aspects of the present invention such as that depicted in FIG. 1, secondary handles 110 are folding handles contained within a recess of housing 102 such that when secondary handle 110 is in a folded state, it lies within the recess and does not extend beyond the respective outwardly facing surface of housing 102. Similar to the design of primary handle 108, the recessed nature of these handles allows animal carrier 100 to be secured in a secured in a vehicle or other location via seatbelts, bungee cables, or other retaining mechanisms, without the interference of one or more protruding secondary handles 110. In one aspect of the present invention, the width of the aperture within secondary handle 110 is at least four inches wide to accommodate passage therethrough of a seatbelt of standard size. Locking mechanisms may also be provided for secondary handles 110 such as those discussed above for primary handle 108. For example, a clip such as clip 136 may be provided for snapping secondary handle 110 into a locked position whenever it is not in use. However, varying types of locking and freely moveable secondary handles 110 may be substituted without departing from the scope of the present invention.

In some aspects of the present invention, one or more secondary handles 110 are located in each of sides 122, recessed upwardly facing surface 118, and recessed rearwardly facing surface 302 (FIG. 3). Including a plurality of secondary handles 110 in a plurality of varied locations allows an operator to be assisted by one or more individuals when handling animal carrier 100 (e.g., lifting animal carrier 100 into a vehicle, loading animal carrier 100 onto an airplane, etc.). That is, the operator and his or her assistants may each grasp a secondary handle 110 located on a different area of animal carrier 100. Additionally, such quantity and varied locations of secondary handles 110 allow such handles to be used to securely affix animal carrier 100 to a vehicle, platform, or the like via use of a restraining device. For example, animal carrier 100 may be secured to a vehicle seat by unfolding a portion of secondary handles 110 and passing a seatbelt therethrough. Thereafter, the seatbelt may be inserted into the seatbelt receiving device with which the vehicle is equipped or may be otherwise secured to hold the seatbelt taught with respect to animal carrier 100. Passing the seatbelt through secondary handles 110 minimizes the area in which such seatbelt may slide or otherwise move, minimizing the likelihood that the seatbelt, or other restraining device, will disengage from animal carrier 100. Equipping animal carrier 100 with a plurality of secondary handles 110 allows a user to configure the restraining device using any one or more of secondary handles 110 that are most convenient for the surface to which animal carrier 100 will be attached. However, embodiments of the present invention are envisioned having a lesser quantity of secondary handles 110, or no secondary handles 110, without departing from the scope of the present invention.

In another aspect of the present invention, animal carrier 100 is equipped with eyelet 114. Eyelet 114 allows animal accessories such as animal leashes or other items to be secured to animal carrier 100 in a manner that minimizes the potential for losing such items. For example, in the case of an animal leash, the leash may be attached to eyelet 114 such that if it falls from animal carrier 100, it will not be lost due to its attachment to animal carrier 100. Furthermore, the leash is retained in an easily accessible location that allows an operator of animal carrier 100 to easily access the leash if, for example, the animal will be removed from animal carrier 100 without the need for rummaging through bags or luggage to locate same.

Eyelet 114 also allows a user to attach an animal leash, belt, or similar towing device to animal carrier 100 such that it may be pulled via such device (i.e., without the use of primary handle 108 and/or secondary handles 110 or in conjunction with same). In some such embodiments, eyelet 114 has a triangular shape, which aids in the directional movement of animal carrier 100. That is, when a towing device is affixed to eyelet 114 and pressure is applied to pull animal carrier 100, the triangular shape of eyelet 114 directs the portion of the towing device located internal to eyelet 114 to the distal, pointed end of eyelet 114. The pointed nature of such end minimizes the tendency of the towing device to slide relative to eyelet 114, thereby providing optimized directional control while pulling animal carrier 100. However, non-triangular eyelets may be substituted without departing from the scope hereof.

In some embodiments of the present invention, eyelet 114 is equipped with a retention mechanism such as retention mechanism 138. In the embodiment of the present invention depicted in FIG. 1, retention mechanism 138 is a spring hook clasp, however, alternate mechanisms may be substituted without departing from the scope of the present invention. Retention mechanism 138 may be used to retain the top half of a bifurcated access device 104 in an open position, for example, to allow the animal free access to the opening created thereby or to allow the user easy access to the interior of animal carrier 100 for feeding, watering, petting, and the like.

Some embodiments of the present invention are further equipped with front and rear storage compartments 140 and 142, respectively. These storage compartments facilitate storage of virtually any type of item, whether animal related or otherwise. In some embodiments of the present invention, such compartments are equipped with locking or non-locking lids such as lids 152 and 150 of storage compartments 140 and 142, respectively, however, the present invention is not so limited.

Animal carrier 100 may optionally include indicia 126 such as “Live Animals”, “Pet On Board”, etc. to notify others that an animal is contained within animal carrier 100. Such indicia may be in the form of self-adhesive stickers, may be applied during manufacturing of housing 102, or may be applied to animal carrier 100 using in any one of a variety of systems and methods known in the art.

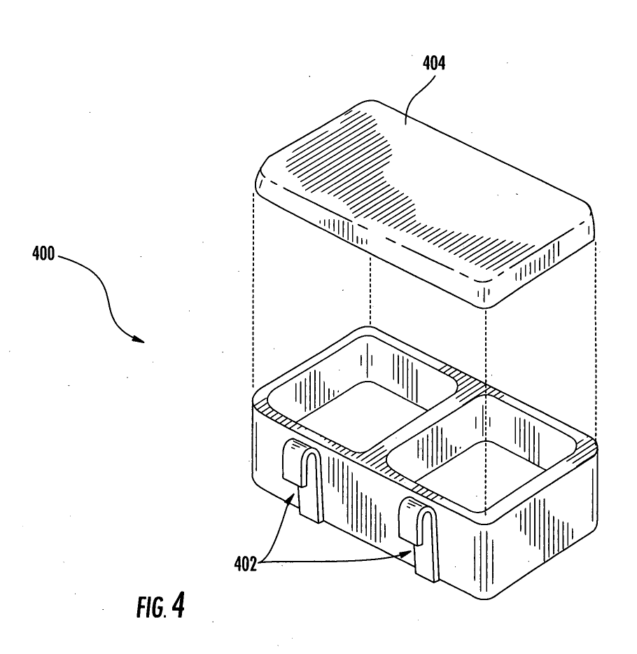

Turning next to FIG. 4, depicted is an exemplary container 400 for use with the present invention. In one aspect of the present invention, container 400 includes a plurality of divided containment areas that may be used to hold food, water, and the like. In the embodiment depicted in FIG. 4, container 400 is coupled to access device 104 via clips 402. That is, the U-shaped portions of clips 402 allow container 400 to hang upon the metal grid of access device 104. Such method of coupling container 400 to access device 104 allows the location to be adjusted such that container 400 may be positioned at an optimal height for the animal contained therein. For example, many owners prefer to elevate food and water for the animal to alleviate stress on the animal's body that would be caused if the animal were forced to lower its head to eat or drink from dishes placed upon a floor. This is particularly true for older animals, which may suffer from any one or more of a variety of physical ailments.

Additionally, the detachable nature of container 400 allows it to be attached to animal carrier 100 for feeding and/or watering of the animal as needed. In addition, the ability to easily remove container 400 allows such removal during transport to prevent spillage of the contents contained therein. In some aspects of the present invention, container 400 includes cover 404. Cover 404 may be a snap locking lid, however, the present invention is not so limited. Preferably, cover 404 is watertight to contain drinking water within container 400 when cover 404 is attached to same. However, non-watertight covers may be substituted without departing from the scope of the present invention. In embodiments of the present invention including cover 404, it is not necessary to remove container 400 during transport, storage, and the like since cover 404 retains the contents of container 400 therein.

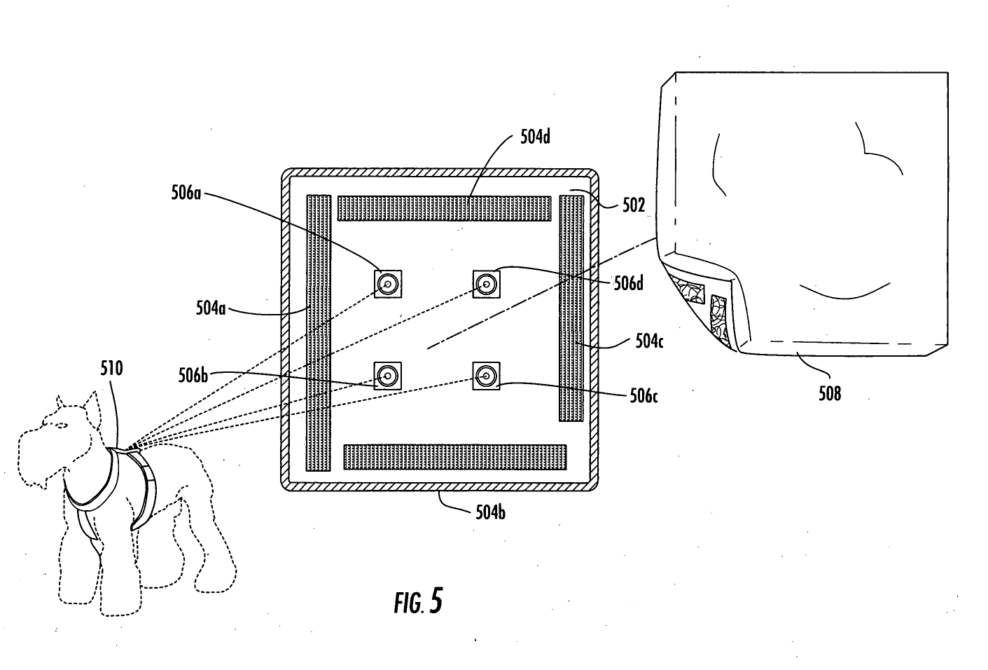

Turning next to FIG. 5, depicted is a cross-sectional view of animal carrier 100 taken along lines 5-5 of FIG. 1, which depicts rear inwardly facing surface 502 of the rear of housing 102. In one aspect of the present invention, rear inwardly facing surface 502 includes accessory attachment mechanisms 504 and restraint attachment mechanisms 506.

Accessory attachment mechanisms 504 allow accessories for animal carrier 100 to be removably attached to the inwardly facing surfaces such rear inwardly facing surface 502 of housing 102 (FIG. 1). Such accessories may include, but are not limited to, cushions, padded wall portions, bedding, etc. Some such accessories are intended to increase the comfort of the animal while it is contained within animal carrier 100. The removable nature of such accessories facilitates cleaning and/or replacement of same. In some embodiments of the present invention, accessory attachment mechanisms are Velcro® pieces or the like, which are glued or otherwise adhered to the inwardly facing surfaces of housing 102 (FIG. 1). In such embodiments, the accessories, such as padding accessory 508, are fitted with mating Velcro® pieces to facilitate attachment of such accessories to such inwardly facing surfaces. However, alternate attachment mechanisms may be substituted without departing from the scope of the present invention.

Inwardly facing surfaces of housing 102 (FIG. 1) such as rear inwardly facing surface 502 may also be equipped with restraint attachment mechanisms 506. Such restraints may include, but are not limited to, harnesses, which may hold the animal securely in place during transportation of the animal. This may increase the comfort of the animal while it is contained within animal carrier 100 by preventing the animal from sliding around within animal carrier 100. The removable nature of such restraints facilitates cleaning and/or replacement of same, as well as use of same external to animal carrier 100. For example, the animal may wear the restraint at all times, particularly if such restraint includes a mechanism for attaching a leash or the like thereto. In some embodiments of the present invention, restraint attachment mechanisms are snap receiving bases or the like, which are glued or otherwise adhered to the inwardly facing surfaces of housing 102 (FIG. 1). In such embodiments, the restraints, such as harness restraint 510, are fitted with mating snaps to facilitate attachment of such restraints to restraint attachment mechanisms 506. However, alternate attachment mechanisms may be substituted without departing from the scope of the present invention. Also, although accessory and restraint attachment mechanisms are depicted on rear inwardly facing surface 502, such mechanisms may be attached to any inwardly facing surface of housing 102 (FIG. 1), or they may be omitted entirely, without departing from the scope of the present invention.

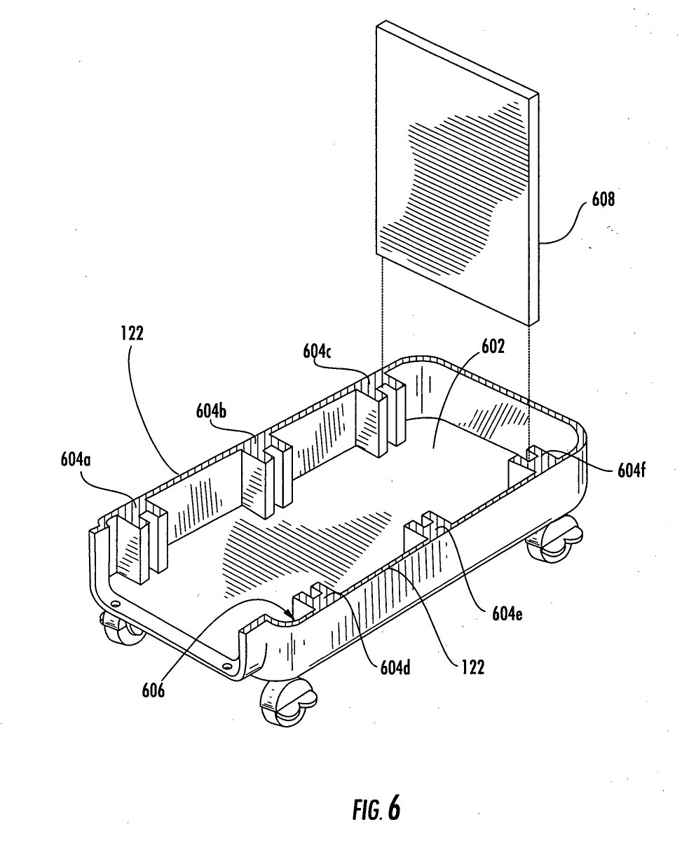

Referring next to FIG. 6, depicted is a cross-sectional view of animal carrier 100 taken along lines 6-6 of FIG. 1, which depicts bottom inwardly facing surface 602 of the bottom of housing 102 (FIG. 1) as well as side inwardly facing surfaces 606 of sides 122. In one aspect of the present invention, side inwardly facing surfaces 606 include partition attachment mechanisms 604.

Partition attachment mechanisms 604 allow partitions, such as partition 608, to be removably attached atop bottom inwardly facing surface 602 of housing 102 (FIG. 1). Such partitions may include, but are not limited to, boards having a width slightly less than the width of animal carrier 100 and a height that is some fraction of the height of animal carrier 100 (e.g., one-quarter, one-half, etc.). The partitions may be made of any material safe for animals including, but not limited to, plastic, wood, etc. Some such partitions are intended to partition the floor space within animal carrier 100 to make it more suitable to the size of the animal, which may increase the comfort of the animal while it is contained within animal carrier 100. For example, a small animal may feel more comfortable napping in a partitioned third of animal carrier 100 since such partitioning is likely to prevent movement or sliding of the animal within animal carrier 100 during transportation. In such a scenario, the height of the partition may be selected such that it is sufficient to prevent the animal's body from sliding while still allowing the animal to easily step over such partition. However, partitions may be used for other purposes including, but not limited to, storage, training, and the like. In some embodiments of the present invention, partition attachment mechanisms 604 are U-shaped pieces made from wood, plastic, or other material that is not harmful to the animal. Such pieces may be glued, screwed, or otherwise adhered to side inwardly facing surfaces 604 of housing 102. In such embodiments, the partitions simply slide into partition attachment mechanisms 604 and are held in place by gravity. However, alternate attachment mechanisms may be substituted without departing from the scope of the present invention. Also, such attachment mechanisms may be omitted without departing from the scope of the present invention.

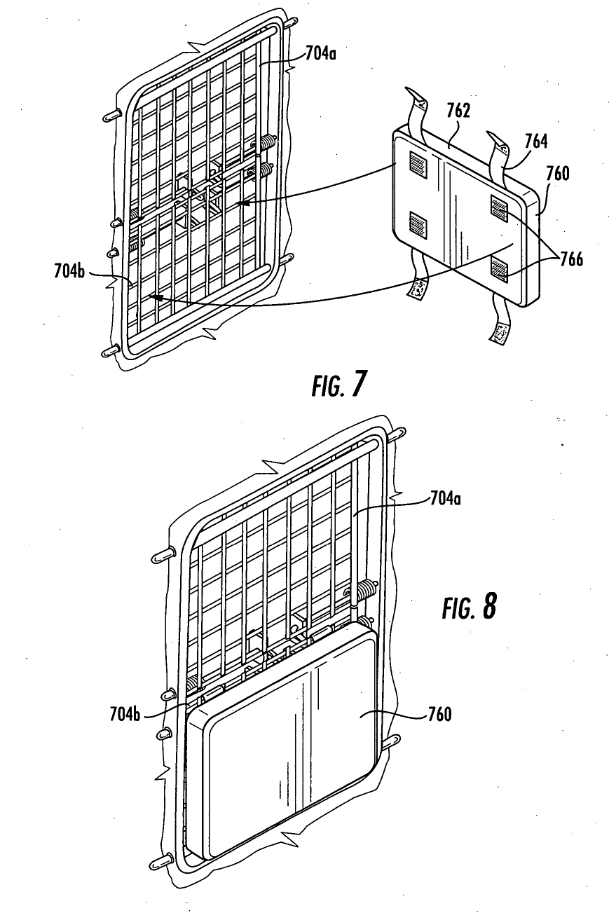

Turning next to FIGS. 7 and 8, depicted are exploded and installed views, respectively, of an optional access device pad 760 in accordance with one embodiment of the present invention. In one aspect of the present invention, access device pad 760 includes access device pad cushion 762, access device pad straps 764, and access device pad fasteners 766. Access device pad 760 may be installed on one or more access devices 704, which are identical to access devices 104 as described above with respect to FIG. 1, to provide additional cushioning for the interior of an animal carrier such as animal carrier 100 (FIG. 1). In addition, the placement of access device pad 760 provides a buffer between the animal contained with the animal carrier and the access device, therefore, in embodiment of the present invention in which the access device is in the form of a grill, such cushioning may prevent an animal from catching its paws or other body parts within the grill of access device 704. In one aspect of the present invention, access device pad 760 is removable, thereby allowing the user to either leave it installed or remove it whenever access device 704 is in use.

In the embodiment of the present invention depicted in FIGS. 7 and 8, access device pad 760 attaches to access device 704b by placing the surface of access device pad 760 upon which access device pad fasteners 766 are mounted against the inwardly facing surface of access device 704b. Thereafter, access device pad straps 764 are wrapped through and around the grid of access device 704b as desired by the user. When such straps are in the proper position, the ends thereof may be fastened to a respective access device pad fastener 766 to secure access device pad 760 to access device 704b. In some aspects of the present invention, access device pad fasteners 766 are Velcro® sections and the ends of access device pad straps 764 are also equipped with mating Velcro® sections. However, mechanisms other than straps and Velcro® sections may be substituted for mounting access device pad 760 to access device 704b without departing from the scope of the present invention. Substitutions may be necessary in scenarios in which access door 704b is not in the form of a grill.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined by the appended claims.

I claim:

1. An animal containment and transportation apparatus comprising:
a housing;
at least one access device coupled to said housing for placing at least one animal in said housing; and
at least one wheel mechanism coupled to at least one downwardly facing side of said housing to facilitate movement of said housing;
wherein said at least one access device is partitioned to allow a user of said apparatus to open a portion of said access device while a remainder of said access device remains in a closed position.

2. An apparatus according to claim 1,
wherein each of said at least one access device includes two independent access device segments; and
wherein each of said access device segments is equipped with at least one of the group consisting of a retention mechanism, a locking mechanism, and combinations thereof.

3. An animal containment and transportation apparatus comprising:
a housing,
at least one access device coupled to said housing for placing at least one animal in said housing; and
at least two wheel mechanisms coupled to at least one downwardly facing side of said housing to facilitate movement of said housing;
wherein at least one of a first of said at least two wheel mechanisms is located toward a rear end of said housing and at least one of a second of said at least two wheel mechanisms is located toward a front end of said housing; and
wherein said at least one of a first of said at least two wheel mechanisms are fixed and said at least one of a second of said at least two wheel mechanisms swivel.

4. An animal containment and transportation apparatus comprising:
a housing;
at least one access device coupled to said housing for placing at least one animal in said housing; and
at least one wheel mechanism coupled to at least one downwardly facing side of said housing to facilitate movement of said housing, said at least one wheel mechanism equipped with at least one foot-actuated locking mechanism.

5. An animal containment and transportation apparatus comprising:
a housing;
at least one access device coupled to said housing for placing at least one animal in said housing; and
at least one wheel mechanism coupled to at least one downwardly facing side of said housing to facilitate movement of said housing, said at least one wheel mechanism equipped with at least one shock absorption mechanism.

6. An apparatus according to claim 5, wherein at least a portion of said at least one shock absorption mechanism is an elastomeric material.

7. An animal containment and transportation apparatus comprising:
a housing;
at least one access device coupled to said housing for placing at least one animal in said housing;
at least one wheel mechanism coupled to at least one downwardly facing side of said housing to facilitate movement of said housing; and
at least one primary handle to facilitate said movement of said housing, said at least one primary handle having an adjustable length.

8. An apparatus according to claim 7, further comprising:
at least one primary handle locking mechanism for locking said at least one primary handle at said adjustable length.

9. An animal containment and transportation apparatus comprising:
a housing;
at least one access device coupled to said housing for placing at least one animal in said housing;
at least one wheel mechanism coupled to at least one downwardly facing side of said housing to facilitate movement of said housing; and
at least one primary handle to facilitate said movement of said housing;
wherein said at least one primary handle folds to a folded position atop said housing; and
wherein said at least one primary handle does not protrude beyond a rearwardly facing surface of said housing when said at least one primary handle is in said folded position.

10. An apparatus according to claim 9, further comprising:
at least one primary handle locking mechanism for locking said at least one primary handle in said folded position.

11. An apparatus according to claim 10, wherein said at least one primary handle locking mechanism includes at least one of the group consisting of a clip, a strap, and combinations thereof.

12. An animal containment and transportation apparatus comprising:
a housing;
at least one access device coupled to said housing for placing at least one animal in said housing;
at least one wheel mechanism coupled to at least one downwardly facing side of said housing to facilitate movement of said housing; and
at least one secondary handle;
wherein said at least one secondary handle folds to a folded position below at least one surface of said housing; and
wherein said at least one secondary handle does not protrude beyond said at least one surface of said housing when said at least one secondary handle is in said folded position.

13. An apparatus according to claim 12, wherein said at least one secondary handle is sized to allow at least one seatbelt to pass therethrough.

14. An apparatus according to claim 12, further comprising:
at least one secondary handle locking mechanism for locking said at least one secondary handle in said folded position.

15. An apparatus according to claim 14, wherein said at least one secondary handle locking mechanism includes at least one of the group consisting of a clip, a strap, and combinations thereof.

16. An animal containment and transportation apparatus comprising:
a housing;
at least one access device coupled to said housing for placing at least one animal in said housing;
at least one wheel mechanism coupled to at least one downwardly facing side of said housing to facilitate movement of said housing; and
at least one eyelet coupled to said housing.

17. An apparatus according to claim 16, wherein said eyelet is triangular.

18. An apparatus according to claim 16, further comprising:
at least one retention mechanism coupled to said eyelet.

19. An apparatus according to claim 16, wherein said at least one retention mechanism retains at least a portion of said at least one access device in an at least partially open position.

20. An apparatus according to claim 16, wherein said at least one retention mechanism is a spring hook clasp.

21. An animal containment and transportation apparatus comprising:
a housing having at least one storage compartment located in a location selected from the group consisting of in at least one upwardly facing surface of said housing, atop at least one upwardly facing surface of said housing, and combinations thereof;
at least one access device coupled to said housing for placing at least one animal in said housing; and
at least one wheel mechanism coupled to at least one downwardly facing side of said housing to facilitate movement of said housing.

22. An apparatus according to claim 21, wherein said at least one storage compartment includes at least one of the group consisting of a locking lid and a non-locking lid.

23. An animal containment and transportation apparatus comprising:
a housing;
at least one access device coupled to said housing for placing at least one animal in said housing;
at least one wheel mechanism coupled to at least one downwardly facing side of said housing to facilitate movement of said housing; and
at least one container removably attached to said housing.

24. An apparatus according to claim 23, wherein said at least one container attaches to said at least one access device via at least one clip.

25. An apparatus according to claim 23, wherein a height of attachment of said at least one container is adjustable.

26. An apparatus according to claim 23, wherein said at least one container includes at least two compartments.

27. An apparatus according to claim 23, wherein said at least one container includes at least one of the group consisting of a locking lid and a non-locking lid.

28. An animal containment and transportation apparatus comprising:
a housing;
at least one access device coupled to said housing for placing at least one animal in said housing;
at least one wheel mechanism coupled to at least one downwardly facing side of said housing to facilitate movement of said housing; and
at least one attachment mechanism for attaching at least one of the group consisting of an accessory, a restraint, and combinations thereof to said housing.

29. An apparatus according to claim 28, wherein said accessory includes at least one of the group consisting of a cushion, a pad, a wall portion, bedding, and combinations thereof.

30. An apparatus according to claim 28, wherein at least a portion of said attachment mechanism is Velcro®.

31. An apparatus according to claim 28, wherein said restraint is a harness.

32. An animal containment and transportation apparatus comprising:
a housing;
at least one access device coupled to said housing for placing at least one animal in said housing;
at least one wheel mechanism coupled to at least one downwardly facing side of said housing to facilitate movement of said housing; and
at least one partition for partitioning a space internal to said housing.
